(19) United States
(12) Patent Application Publication
(10) Pub. No.: US 2004/0230454 A1
(43) Pub. Date: Nov. 18, 2004

(54) Logistics expense settling system and method

(76) Inventors: Rien Yang, Tu-chen (TW); Wenbo Mao, Shenzhen (CN); Sheng Chi Luo, Tu-chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/848,218

(22) Filed: May 17, 2004

(30) Foreign Application Priority Data
May 16, 2003 (TW) 92113411

(51) Int. Cl. G06F 17/60

(52) U.S. Cl. 705/1

(57) ABSTRACT

A system for settling logistics expenses includes a plurality of client computers (10), a first host (12), a second host (16) and a database (14). The first host comprises an authority controlling module (21), a data maintaining module (22), an expense carrying forward module (23), an expense apportionment module (24), an expense auditing module (25), an expense analyzing module (26), and a statement generating module (27). The expense carrying forward module is for carrying forward expenses to corresponding accounts according to predefined account segments. The expense apportionment module is for apportioning expenses. The expense auditing module is for auditing expenses. The expense analyzing module is for analyzing expenses. The statement generating module is for generating statements according to terms set by a user. The second host is for retrieving account comparison results and statements from the first host.

### BACKGROUND OF THE INVENTION

1. Field of the Invention

The present invention relates to a logistics expense settling system and method, and particularly to a logistics expense settling system and method that can audit and analyze logistics expenses.

2. Background of the invention

Efficient logistics management is vital for vast multinational manufacturing corporations. The settling of logistics expenses needs to be timely, accurate, auditable and analyzable. Traditional logistics expense settling involves calculating expenses according to source material, and accounting for the expense to corresponding accounts manually. Accountants check requested payments at their settling dates, and settle the logistics expenses with dealers accordingly. These procedures require considerable manpower, and are prone to human error.

Computer-aided logistics management, scheduling and e-business logistics systems are disclosed in a number of patents. Some of these systems relate to selection of logistics methods and quote methods. However, most of these systems do not address the tasks of auditing and analyzing logistics expenses.

US Pat. Publication No. 20020116328 published on Aug. 22, 2002 and entitled “Automotive Finance Portal” discloses a method of processing an automotive finance transaction. The method includes the steps of inputting business rules and rates for financial institutions; entering criteria of a chosen vehicle; selecting a financial institution; generating a comparative quote scheme for the chosen vehicle; and selecting a set of terms from the comparative quote scheme.

The above-described automotive finance portal method concentrates on the suitability of logistics selections and financing selections. The method does not provide for auditing and analyzing of logistics expenses.

### SUMMARY OF THE INVENTION

Accordingly, a main objective of the present invention is to provide a logistics expense settling system and method which can automatically compare a requested payment with the balance of a corresponding account or group category, and transmit an account comparison result to a relevant department for consideration in relation to payment.

Another objective of the present invention is to provide a logistics expense settling system and method which can automatically integrate with external logistics systems and reduce manual inputting of data.

To accomplish the above objectives, a logistics expense settling system in accordance with a preferred embodiment of the present invention includes a plurality of client computers, a first host, a database, and a second host. Each client computer provides a user interface for inputting and displaying basic information. The first host includes: an authority controlling module for defining and controlling an operational authority for each user; a data maintaining module for maintaining basic information; an expense carrying forward module for carrying forward expenses to corresponding accounts according to the predefined account segments; an expense apportionment module for apportioning expenses that relate to more than one department or more than one product; an expense auditing module for auditing expenses; an expense analyzing module for analyzing expenses; and a statement generating module for generating statements according to particular terms set by a user. The database stores basic information, balances of accounts and of group categories, account comparison results and statements. The second host retrieves the account comparison results and statements from the first host. The client computers are connected to the first host through an electronic network. The first host is connected to the database through a connection, and connected to the second host through an Intranet.

Further, the present invention provides a logistics expense settling method comprising the steps of: (a) setting user's authority; (b) setting basic information through a user interface; (c) determining whether there is an external logistics system, if there is, carrying forward expenses, if there isn't, accounting for expenses; (d) apportioning expenses and carrying forward the apportioned balances to corresponding accounts; (e) determining whether a requested payment is equal to the balance of a corresponding account or of a group category, if yes, transmitting an account comparison result to the second host, if no, searching differences and transmitting an account comparison result to the second host; (f) analyzing expenses; and (g) generating statements.

Other objects, advantages and novel features of the present invention will be drawn from the following detailed description with reference to the attached drawings, in which:

### BRIEF DESCRIPTION OF THE DRAWINGS

FIG. 1 is a schematic diagram of hardware infrastructure of a logistics expense settling system in accordance with the preferred embodiment of the present invention;

FIG. 2 is a schematic diagram of main function units of the first host of the logistics expense settling system of FIG. 1; and

FIG. 3 is a flowchart of a preferred method for implementing the logistics expense settling system of the present invention.

### DETAILED DESCRIPTION OF THE INVENTION

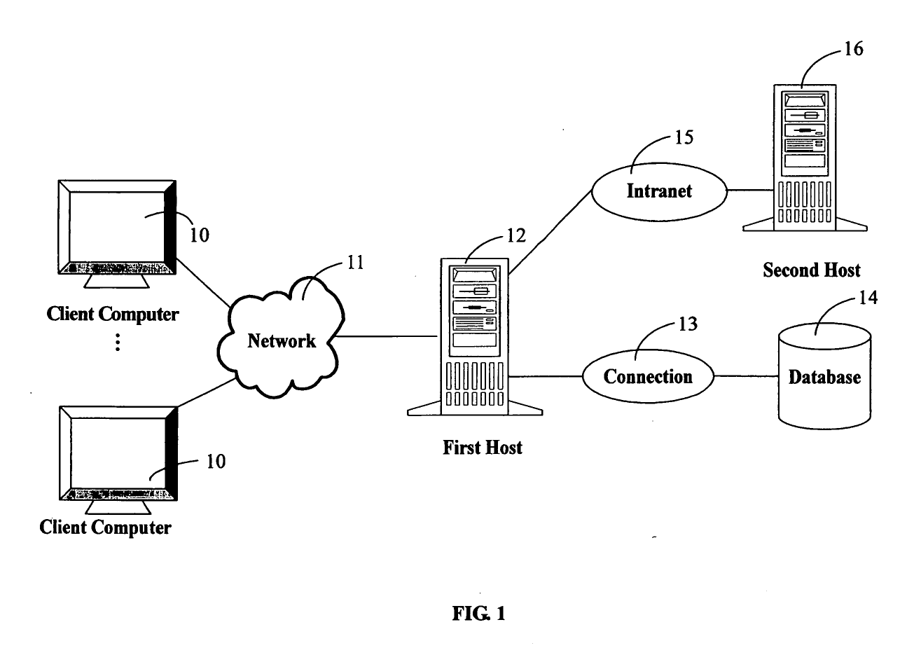

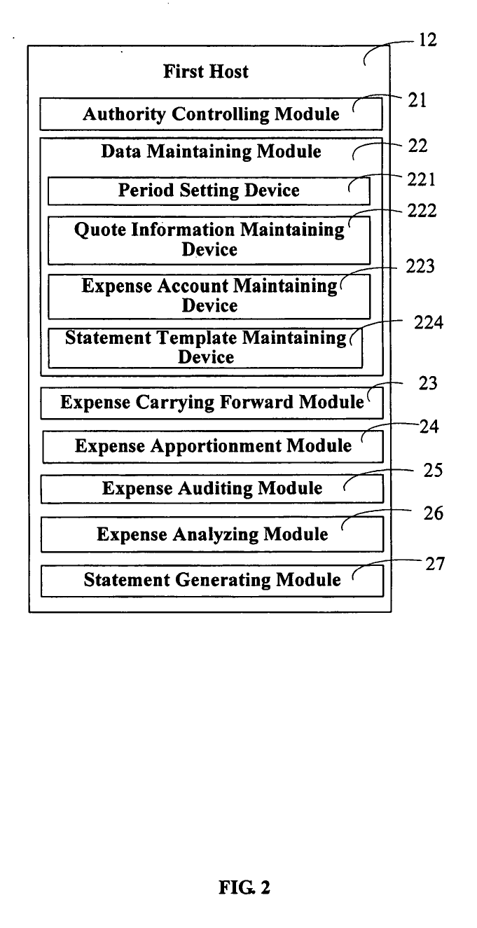

FIG. 1 is a schematic diagram of hardware infrastructure of a logistics expense settling system in accordance with the preferred embodiment of the present invention. The logistics expense settling system comprises a plurality of client computers 10, a first host 12, a database 14, and a second host 16. The client computers 10 are connected to the first host 12 through an electronic communications network 11, which may for example be an intranet or the Internet. The first host 12 is connected to the database 14 through a connection 13, and is connected to the second host 16 through an intranet 15. The connection 13 is database connectivity such as an Open Database Connectivity (ODBC), or a Java Database Connectivity (JDBC). Each client computer 10 provides an interactive user interface for maintaining basic information. The first host 12 comprises a plurality of function units (described in detail below in relation to FIG. 2), for retrieving and analyzing data obtained from the client computers 10 and from other systems such as an external logistics system (not shown in FIG. 1), and for generating statements and transmitting the statements to the second host 16. The external logistics system is for providing logistics information, and may include a booking management system, a hub management system and a logistics service system. The logistics information includes the category, quantity, dispatch date, department, dealer, delivery mode and destination of various delivered goods. The delivery modes mainly include ocean shipping, airfreight, land carriage, and through transport. The statements include general expense statements, detailed expense statements, expense history comparing statements, and expense analysis statements. The database 14 stores the basic information, balances of accounts and of group categories, account comparison results, and the statements. Account comparison results, and balances of accounts and of group categories are explained in more detail below. The second host 16 is for retrieving the account comparison results and statements from the first host 12.

FIG. 2 is a schematic diagram of main function units of the first host 12. The first host 12 comprises an authority controlling module 21, a data maintaining module 22, an expense carrying forward module 23, an expense apportionment module 24, an expense auditing module 25, an expense analyzing module 26, and a statement generating module 27. The authority controlling module 21 defines and controls an operational authority for each user of the logistics expense settling system. The data maintaining module 22 maintains basic information, including by way of adding, modifying, searching and deleting basic information. The basic information may include expense periods, quoted prices, expense accounts and statement templates. The data maintaining module 22 comprises and executes a period setting device 221, a quote information maintaining device 222, an expense account maintaining device 223, and a statement template maintaining device 224. The period setting device 221 is used for setting expense periods. This allows a user to define a particular expense period to generate an individualized statement. The expense period may for example be a monthly or quarterly period, or a calendar or fiscal year. The quote information maintaining device 222 defines and updates quote information, which information may include delivery modes, dispatch dates, destinations, dealers and so on. The user inputs a latest quoted price, and the logistics expense settling system stores a history of quoted prices in the database 14. The expense account maintaining device 223 is for maintaining expense accounts, which include account segments, suspense accounts and group categories. Account segment refers to a configuration of an expense account. Customarily, an expense account can be divided into four segments, and each segment can be designated with a different number in accordance with different needs. For example, a user may define the first segment as a department code, the second segment as a product code, the third segment as a dealer code, and the fourth segment as a delivery mode code. Suspense accounts are for temporarily collecting expenses that cannot be apportioned to an account. Group categories are for grouping accounts according to one or more than one specific segment, each group category comprising at least one segment. For example, users can define the accounts whose first segment is 03 as a group category. Thus the total of balances of the accounts included in that group category indicate expenses of the department that is represented by 03. Group categories are convenient for calculating expenses and generating an individualized statement. The statement template maintaining device 224 maintains types and forms of statements.

The expense carrying forward module 23 carries forward expenses to corresponding accounts according to the predefined account segments. If there is an external logistics system, the expense carrying forward module 23 automatically carries forward expenses. That is, the expense carrying forward module 23 carries forward expenses from the external logistics system to the corresponding accounts, and temporarily collects in the suspense accounts any expenses that cannot be apportioned to one account. If there is no external logistics system, the user accounts for expenses using other sources such as bills of lading. The user enters the expenses in the corresponding accounts, and stores the balances in the database 14. In other words, the function of carrying forward expenses is to transfer a balance from one account to another account automatically. In the preferred embodiment of the present invention, the balances are automatically transferred from the external logistics system to the corresponding accounts as predefined by the logistics expense settling system. Compare this with the function of accounting for expenses, which is to record business to corresponding accounts through manual input.

The expense apportionment module 24 apportions expenses that relate to more than one department or more than one product. Expenses that are firstly carried forward or accounted for to the suspense accounts are subsequently apportioned by the expense apportionment module 24. After apportioning, the expense carrying forward module 23 carries forward the apportioned balances of suspense accounts to corresponding accounts, and stores the apportioned balances in the database 14.

The expense auditing module 25 is for auditing expenses. The expense auditing module 25 performs auditing by way of checking a payment request made by a dealer. That is, the expense auditing module 25 determines whether a requested payment is equal to the balance of a corresponding account or group category, and transmits the account comparison result to the second host 16. Typically, when a dealer requests a payment, the expenses either relate to only one account or to more than one account. When the expenses relate to more than one account, they are typically included in a single group category. Accordingly, a user selects the corresponding account or group category for the requested payment to be compared with. If the account comparison result is unequal, the account comparison result includes one or more differences between the requested payment and the balance of the corresponding account or group category.

The expense analyzing module 26 performs analyzing by way of comparing the balances of the one or more corresponding accounts or group categories with historical data, other accounts data or other group categories data. The expense analyzing module 26 performs analyzing according to particular terms set by a user. The terms set by the user mainly include departments, products, dealers, delivery modes, dispatch dates, and so on. For example, if there is a need to compare expenses of two particular departments, the user can select the two particular departments' IDs. Accordingly, the user can select two corresponding accounts or two group categories whose segments respectively represent the particular departments. In this way, the expense analyzing module 26 performs analyzing by way of comparing the balances of the two corresponding accounts or the two group categories.

The statement generating module 26 generates statements according to predefined statement templates and particular terms set by a user. The statement templates include a general expense statement, a detailed expense statement, an expense history comparing statement, and an expense analysis statement. The statements can be transmitted to the second host 16 at predetermined times or at any selected time.

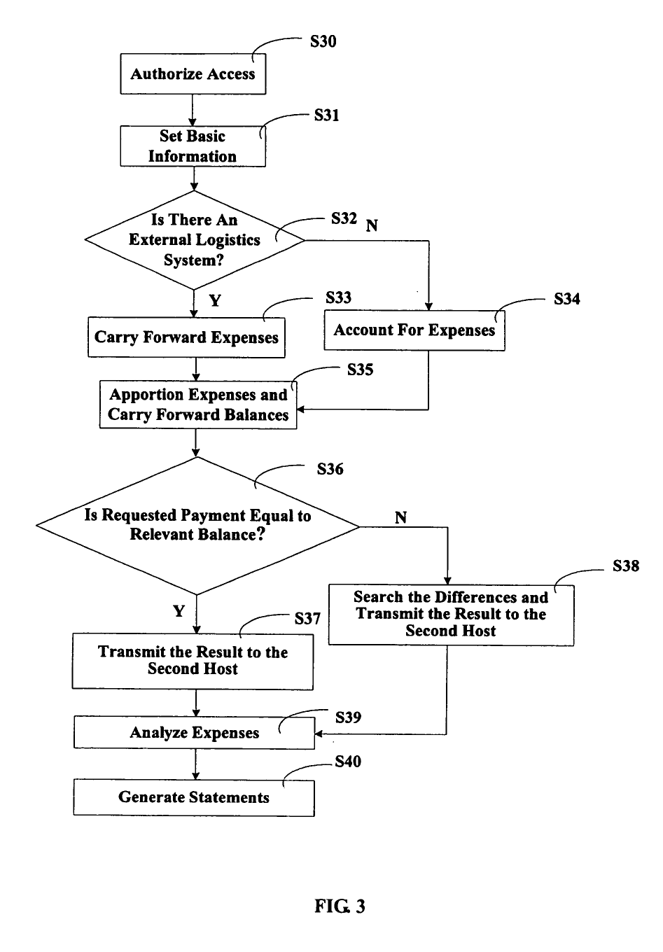

FIG. 3 is a flowchart of a preferred method for implementing the logistics expense settling system of the present invention. In step S30, the authority controlling module 21 authorizes users to access different operational interfaces. In step S31, a user sets basic information such as expense periods, quoted prices, expense accounts, and statement templates. The basic information as set is stored in the database 14, and can be searched by any user through any client computer 10. In step S32, the user determines whether there is an external logistics system. If there is an external logistics system, in step S33, the expense carrying forward module 23 automatically carries forward expenses from the external logistics system to corresponding accounts, and temporarily collects in suspense accounts any expenses that cannot be apportioned. If there is no external logistics system, in step S34, the user manually accounts for expenses to corresponding accounts according to other sources such as bills of lading, and stores the balances in the database 14. In step 35, the expense apportionment module 24 apportions expenses that relate to more than one department or more than one product. The expense carrying forward module 23 carries forward the apportioned balances of suspense accounts to corresponding accounts, and stores the apportioned balances in the database 14. Thereupon, when a dealer requests payment from a relevant financial department, the procedure proceeds to step S36. That is, the expense auditing system 25 checks the requested payment to determine whether it is equal to the balance of the corresponding account or group category. If equal, in step S37, the expense auditing system 25 transmits the account comparison result to the second host 16 for payment. If not equal, in step S38, the expense auditing system 25 searches differences between the requested payment and the balance of the corresponding account or group category, and transmits the account comparison result including one or more differences to the second host 16. In step S39, the expense analyzing module 26 analyzes expenses according to particular terms set by a user. In step S40, the statement generating module 27 generates corresponding statements. The statements can be displayed to the user through the interface, stored in the database 14, and printed.

Although the present invention has been specifically described on the basis of a preferred embodiment and a preferred method, the invention is not to be construed as being limited thereto. Various changes or modifications may be made to the embodiment and method without departing from the scope and spirit of the invention.

What is claimed is:

1. A logistics expense settling system for auditing and analyzing logistics expenses, the logistics expense settling system comprising:
a plurality of client computers, each of the client computers providing a user interface for inputting and displaying data;
a database for storing information;
a first host for auditing and analyzing logistics expenses, comprising:
a data maintaining module for adding, modifying, searching and deleting basic information;
an expense auditing module for auditing logistics expenses; and
an expense analyzing module for analyzing logistics expenses; and
a second host for retrieving information transmitted from the first host.

2. The logistics expense settling system according to claim 1, wherein the data maintaining module comprises:
a period setting device for setting expense periods;
a quote information maintaining device for defining and updating quote information;
an expense account maintaining device for maintaining expense accounts; and
a statement template maintaining device for maintaining types and forms of statements.

3. The logistics expense settling system according to claim 1, wherein the expense accounts comprise group categories for grouping accounts.

4. The logistics expense settling system according to claim 1, wherein the first host comprises an authority controlling module for defining and controlling an operational authority for each user.

5. The logistics expense settling system according to claim 1, wherein the first host comprises a statement generating module for generating statements according to predefined statement templates and terms set by a user.

6. The logistics expense settling system according to claim 1, wherein the first host comprises an expense apportionment module for apportioning expenses related to more than one account.

7. The logistics expense settling system according to claim 1, wherein the expense auditing module performs auditing by way of checking a payment request made by a dealer in order to determine whether the requested payment is equal to the balance of a corresponding account, and transmitting an account comparison result to the second host.

8. The logistics expense settling system according to claim 1, wherein the expense auditing module performs auditing by way of checking a payment request made by a dealer to determine whether the requested payment is equal to the balance of a corresponding group category, and transmitting an account comparison result to the second host.

9. A logistics expense settling method, comprising the steps of:
setting basic information through a user interface;
determining whether there is an external logistics system providing logistics information;
carrying forward expenses to corresponding accounts automatically if there is an external logistics system;
apportioning expenses and carrying forward apportioned expenses to corresponding accounts;
determining whether a payment request made by a dealer is equal to the balance of a corresponding account or group category;
searching differences and transmitting an account comparison result to a host if the requested payment is not equal to the balance of the corresponding account; and
transmitting the account comparison result to the host directly if the requested payment is equal to the balance of the corresponding account.

10. The method according to claim 9, further comprising the step of analyzing expenses.

11. The method according to claim 9, further comprising the step of accounting for expenses to corresponding accounts if there is no external logistics system.

12. The method according to claim 9, further comprising the step of generating a statement according to one or more terms set by a user.
